(19) United States
(12) Patent Application Publication
(10) Pub. No.: US 2022/0108653 A1
(43) Pub. Date: Apr. 7, 2022

(54) BOUNDARY DISTORTION COMPENSATION FOR MULTI-PIXEL DENSITY OLED DISPLAY PANEL

(71) Applicant: GOOGLE LLC, Mountain View, CA (US)

(72) Inventors: Hyunchul Kim, San Jose, CA (US); Sun-il Chang, San Jose, CA (US)

(21) Appl. No.: 17/311,651

(22) PCT Filed: Aug. 1, 2019
(86) PCT No.: PCT/US2019/044665

§ 371 Date: Jun. 7, 2021

(51) Int. Cl. G09G 3/3208; G09G 5/02

(52) U.S. Cl. CPC G09G 3/3208; G09G 5/02; G09G 2320/0666; G09G 2320/0242; G09G 2320/0233

(57) ABSTRACT

A method includes receiving original image content represented in a first color model, determining converted image content represented in a second color model from the original image content represented in the first color model, obtaining a distortion compensation profile that compensates for differences in response characteristics between the first portion of the display and the second portion of the display, determining compensated image content represented in the second color model based on the converted image content and the distortion compensation profile, determining reconverted compensated image content represented in the first color model from the compensated image content represented in the second color model, and providing the reconverted compensated image content represented in the first color model for display on a display panel.

### BACKGROUND

Electronic devices include displays that can change in luminance and color.

### SUMMARY

This specification describes techniques, methods, systems, and other mechanisms for boundary distortion compensation. An organic light emitting diode (OLED) display panel that has portions with multiple different pixel densities across the display panel may vary in luminance and color even when the portions are driven with the same inputs. For example, a first portion driven with red, green, blue (RGB) pixel values of (255, 255, 255) may be slightly more bright and slightly less yellow than a second portion driven with RGB pixel values of (255, 255, 255). The luminance and color shown by the display panel in response to inputs is referred to herein as response characteristics.

The difference in response characteristics may be caused by manufacturing differences between the portions of the display panel with different pixel densities. For example, a display panel with portions with different pixel densities may be formed of a first subpanel with its own response characteristics surrounded by a second subpanel with its own different response characteristics.

The difference between the two portions of the display panel may cause a boundary between the two portions to be noticeable to the human eye. For example, the difference in luminance between the two portions may be very noticeable right at the border when the two portions are adjacent to one another. The visible difference at boundaries between portions is referred to herein as boundary distortion. Boundary distortion may be visibly jarring to a user and may distract a user. Additionally, boundary distortion may make it obvious that a display panel has two different portions.

Boundary distortion compensation may compensate for boundary distortion. For example, boundary distortion compensation may be used to make the two portions of the display show luminance and color that are more similar. Compensating for boundary distortion may hide the difference in the portions of the display from viewers and users may not even realize the display has portions with different pixel densities.

Generally, boundary distortion compensation may be performed by converting image content represented in a first color model to a second color model, applying a distortion compensation profile represented in the second color model to determine compensated image content, reconverting the compensated image content to be represented in the first color model, and then providing the reconverted compensated image content for display.

In general, one innovative aspect of the subject matter described in this specification can be embodied in receiving original image content represented in a first color model, determining converted image content represented in a second color model from the original image content represented in the first color model, obtaining a distortion compensation profile that compensates for differences in response characteristics between the first portion of the display and the second portion of the display, determining compensated image content represented in the second color model based on the converted image content and the distortion compensation profile, determining reconverted compensated image content represented in the first color model from the compensated image content represented in the second color model, and providing the reconverted compensated image content represented in the first color model for display on a display panel.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other embodiments can each optionally include one or more of the following features. In some aspects, determining compensated image content represented in the second color model based on the converted image content and the distortion compensation profile includes determining the compensated image content represented in the second color model based on an aggregation of the converted image content and the distortion compensation profile. In some implementations, the distortion compensation profile includes a map of values in the second color model for each pixel in the original image content.

In certain aspects, the distortion compensation profile is determined based on images of the display panel captured by a camera that represents the images in the second color model. In some aspects, the first color model includes a red, green, blue (RGB) color model. In some implementations, the second color model includes a XYZ color model. In certain aspects, obtaining a distortion compensation profile includes retrieving the distortion compensation profile from a non-transitory computer-readable medium.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system before and after boundary distortion compensation.

FIG. 2 is another block diagram of an example system for boundary distortion compensation.

FIG. 3 is flowchart of an example process for boundary distortion compensation.

FIG. 4 is flowchart of an example process for determining a distortion compensation profile.

Like reference numbers and designations in the various drawings indicate like elements.

### DETAILED DESCRIPTION

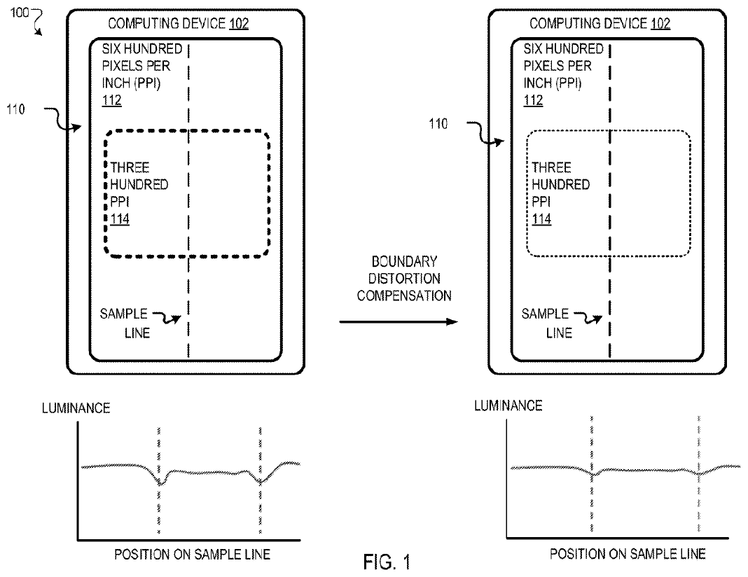

FIG. 1 is a block diagram of an example system 100 before and after boundary distortion compensation. The system 100 includes a computing device 102 that includes the display panel 110. For example, the computing device 102 may be a smartphone, a tablet, or some other device.

The display panel 110 includes a first portion 112 at a first pixel density and a second portion 114 at a second pixel density. For example, the first portion 112 may have six hundred pixels per inch (PPI) and the second portion 114 may have three hundred PPI. The first portion 112 and the second portion 114 may be positioned on the display panel 110 so that the portions share a boundary. For example, the second portion 114 may be surrounded by the first portion 112.

As shown on the left side of FIG. 1, when the display panel 110 displays image content, distortions between the first portion 112 and the second portion 114 may be apparent. As shown in the graph at the bottom of the left side, a luminance along the sample line may change, especially at the boundaries of the first portion 112 and the second portion 114. Accordingly, it may be readily apparent that the display 110 includes two different portions.

Accordingly, the system 100 may use boundary distortion compensation to reduce distortions between the first portion 112 and the second portion 114. As shown on the right side of FIG. 1, when the display panel 110 displays image content with boundary distortion compensation, distortions between the first portion 112 and the second portion 114 may be less apparent. As shown in the graph at the bottom of the right side, a luminance along the sample line changes less than without boundary distortion compensation. Accordingly, it may be less apparent that the display 110 includes two different portions.

While FIG. 1 shows boundary distortion in graphs of the luminance, boundary distortion may also occur in color and the boundary distortion compensation may similarly reduce differences in color between the two portions. Additionally, while FIG. 1 is shown with two nested portions, boundary compensation may similarly be applied to display panels with other number and arrangement of portions. For example, boundary distortion compensation may be used to reduce differences between a display panel with four portions that all have different PPI and are arranged in a grid.

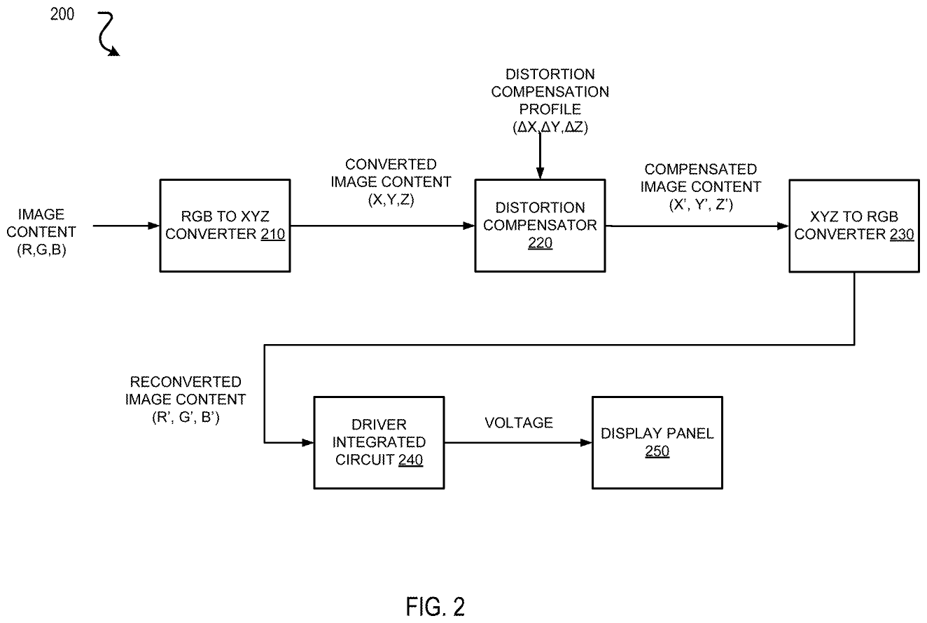

FIG. 2 is another block diagram of an example system 200 for boundary distortion compensation. The system 200 includes a RGB to XYZ converter 210, a distortion compensator 220, a XYZ to RGB converter 230, a driver integrated circuit 240, and a display panel 250. In some implementations, the system 200 may be included in the computing device 102 shown in FIG. 1.

The RGB to XYZ converter 210 may receive image content represented in a RGB color model and determine converted image content represented in a XYZ color model based on the image content. The XYZ color model may be the International Commission on Illumination 1931 XYZ color model, where Y represents luminance, Z represents a S cone response of the human eye, and X is a mix of response curves chosen to be non-negative. Thus, the XYZ color model may represent how humans perceive colors objectively and may be used as a device-independent color distortion judgement metric. Accordingly, actual compensation with the system 200 may occur in the XYZ color model rather than the RGB color model.

For each pixel in the image content, the RGB to XYZ converter 210 may extract the RGB values for the pixel from the image content, and then convert the RGB values to corresponding XYZ values. The conversion may use a matrix that can be obtained by measuring display color spectrums in a mass production line with a spectroradio meter or colorimeter. For example, the RGB to XYZ converter 210 may determine that the image content represents a first pixel at coordinates of (1,1) with RGB values of (255, 255, 255) and then determine XYZ values of (50, 100, 10) for the first pixel, and determine that the image content represents a second pixel at coordinates of (2,1) with RGB values of (222, 222, 222) and then determine XYZ values of (45, 90, 9) for the second pixel.

The distortion compensator 220 may obtain the converted image content represented in the XYZ color model and a distortion compensation profile represented in the XYZ color model, and determine compensated image content represented in the XYZ color model. The distortion compensation profile 220 may specify an amount to modify XYZ values for each pixel in the display panel 250. For example, the distortion compensation profile 220 may specify that a pixel at (1, 1) be decreased by XYZ values of (7, 6, 5) and a pixel at (2, 1) be decreased by XYZ values of (4, 3, 2).

In some implementations, the distortion compensator 220 may determine XYZ values for each pixel in the compensated image content as a sum of the XYZ values specified by the distortion compensation profile for the pixel and the converted image content XYZ values for the pixel. For example, the distortion compensator 220 may determine XYZ values of (43, 94, 5) for a pixel at (1, 1) in the compensated image content from summing XYZ values of (50, 100, 10) for the pixel (1,1) from the converted image content and XYZ values of (−7, −6, −5) for the pixel (1, 1) from the distortion compensation profile.

The XYZ to RGB converter 230 may obtain the compensated image content represented in the XYZ color model and determine reconverted image content represented in the RGB color model from the compensated image content. For example, the XYZ to RGB converter 230 may receive XYZ values of (43, 94, 5) for pixel (1, 1) and determine reconverted image content RGB values of (244, 244, 244) for pixel (1, 1).

The driver integrated circuit 240 may obtain the reconverted image content and determine corresponding voltage that is then applied to the display panel 250. For example, the driver integrated circuit 240 may be configured to map particular RGB values to particular voltages.

The RGB to XYZ converter 210, distortion compensator 220, and XYZ to RGB converter 230 may be variously implemented by hardware or software that executes on hardware. For example, the RGB to XYZ converter 210, distortion compensator 220, and XYZ to RGB converter 230 may be executed by a processor in the computing device 102.

In some implementations, the system 200 may include an upconverter and a ditherer. The upconverter may receive original image content, upconvert the original image content by adding additional bits to each pixel, and then provide the upconverted image content to the RGB to XYZ converter 210. The ditherer may receive reconverted compensated image content from the XYZ to RGB converter 230, dither the image content back to the original number of bits for each pixel in the original image content, and then provide the dithered image content to the driver integrated circuit 240.

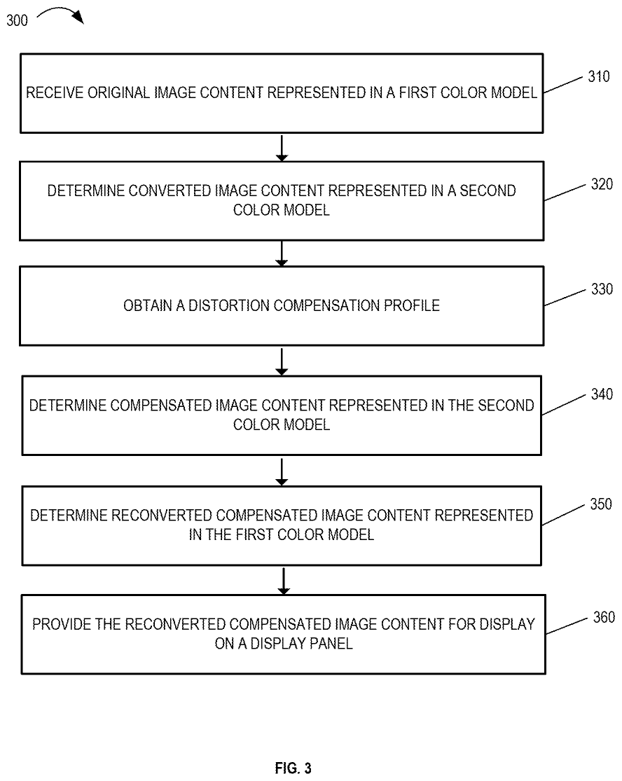

FIG. 3 is flowchart of an example process 300 for boundary distortion compensation. Briefly, and as will be described in more detail below, the process 300 includes receiving original image content represented in a first color model (310), determining converted image content represented in a second color model (320), obtaining a distortion compensation profile (330), determining compensated image content represented in the second color model (340), determining reconverted compensated image content represented in the first color model (350), and providing the reconverted compensated image content for display on a display panel (360). The process 300 may be performed by the system 200, or some other system.

The process 300 includes receiving original image content represented in a first color model (310). For example, the RGB to XYZ converter 210 may receive image content that specifies an image to show across the entire display panel 250, where each pixel in the display panel 250 has corresponding RGB values specified by the image content.

The process 300 includes determining converted image content represented in a second color model (320). For example, the RGB to XYZ converter 210 may convert the RGB value specified by the image content for each pixel into XYZ values for the pixel.

The process 300 includes obtaining a distortion compensation profile (330). For example, the distortion compensator 220 may retrieve a distortion compensation profile from non-transitory computer readable medium on the computing device 102. In some implementations, the distortion compensation profile is a map of values in the second color model for each pixel in the original image content. For each, for each pixel in the display panel 250, the distortion compensation profile may specify XYZ values to add to the converted image content.

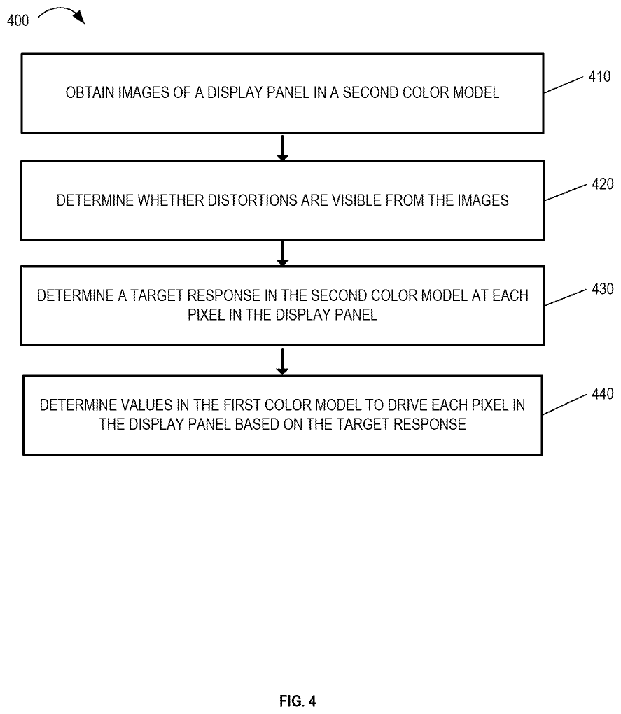

In some implementations, the distortion compensation profile is determined based on images of the display panel captured by a camera that represents the images in the second color model. For example, as further described in reference to FIG. 4, the distortion compensation profile may have been determined during a calibration process at a factory and the distortion compensation profile then stored onto the computing device 102 for later use.

In some implementations, obtaining a distortion compensation profile includes receiving the distortion compensation profile before receiving the original image content represented in the first color model. For example, the distortion compensator 220 may receive the distortion compensation profile during a calibration process that occurs at a factory.

The process 300 includes determining compensated image content represented in the second color model (340). For example, the distortion compensator 220 may determine compensated image content represented by XYZ values based on the converted image content and the distortion compensation profile.

In some implementations, determining compensated image content represented in the second color model based on the converted image content and the distortion compensation profile includes determining the compensated image content represented in the second color model based on an aggregation of the converted image content and the distortion compensation profile. For example, the distortion compensator 220 may sum the distortion compensation profile and the converted image content and use the sum as the compensated image content.

The process 300 includes determining reconverted compensated image content represented in the first color model (350). For example, the XYZ to RGB converter 230 may determine RGB values for each pixel in the display panel 250 based on the compensated image content represented by XYZ values.

The process 300 includes providing the reconverted compensated image content for display on a display panel (360). For example, the reconverted image content may be received by driver integrated circuit 240, which then generates corresponding voltage that is applied to the display panel 250.

FIG. 4 is flowchart of an example process 400 for determining a distortion compensation profile. Briefly, and as described in further detail below, the process 400 includes obtaining images of a display panel in a second color model (410), determining whether distortions are visible from the images (420), determining a target response in the second color model at each pixel in the display panel (430), and determining values in the first color model to drive each pixel in the display panel based on the target response (440).

The process 400 includes obtaining images of a display panel in a second color model (410). For example, a distortion compensation profile generator may receive multiple images of the display panel 250 captured by a camera that stores images with XYZ values, where the images correspond to the display panel 250 responding to various RGB values at various pixels in the display panel 250. The compensation profile generator may be implemented by hardware or software that executes on hardware.

The process 400 includes determining whether distortions are visible from the images (420). For example, the compensation profile generator may determine whether the images pass a color uniformity check. In some implementations, the color uniformity check may fail if max(CIEDE2000(ui,vj)-CIEDE2000(uk,vl)) is greater than one, where ui and vi are the i-th and j-th row and column, respectively, and uk and vl are the k-th and l-th row and column, respectively.

The process 400 includes determining a target response in the second color model at each pixel in the display panel (430). For example, the compensation profile generator may determine a function that represents XYZ values for each coordinate in the display panel, and then apply a low pass filter to determine a target response in the XYZ color model.

Alternatively, in some implementations, the compensation profile generator may determine a first function that represents X values for each coordinate in the display, a second function that represents Y values for each coordinate in the display, and a third function that represents Z values for each coordinate in the display. In some implementations, the functions may be represented as fx(u,v) for CIE X value at (u,v), fx(u,v) for CIE Y value at (u,v), and f_{z}(u,v) for CIE Z value at (u,v), where u is a pixel location in a horizontal direction and v is a pixel location in a vertical direction. The target response may then be determined with the equations:

f′_{X}(u,v)=f_{X}(u,v)+Δx(u,v)

f′_{Y}(u,v)=f_{Y}(u,v)+Δy(u,v)

f′_{Z}(u,v)=f_{Z}(u,v)+Δz(u,v)

where Δx(u,v), Δy(u,v), Δz(u,v) are a difference between the respective function of functions fₓ, f_{y}, and f_{z} and the function after being low pass filtered.

The process 400 includes determining values in the first color model to drive each pixel in the display panel based on the target response (440). For example, the compensation profile generator may determine a distortion compensation profile as a difference between the function that represents XYZ values for each coordinate in the display panel and the low pass filtered function, then determine a compensated function based on adding the function that represents XYZ values for each coordinate in the display panel and the difference, and then determine a function that represents RGB values from the compensated function. In an example, with the equations above, the values in the first color model may be determined with the below equation:

$$M ( u , v ) ( \begin{matrix}{{f}^{′}}_{x} ( u , v ) \\ {{f}^{′}}_{y} ( u , v ) \\ {{f}^{′}}_{z} ( u , v )\end{matrix} ) = ( \begin{matrix}R ( u , v ) \\ G ( u , v ) \\ B ( u , v )\end{matrix} ) , \\ M ( u , v ) converts CIE XYZ values to RGB value$$

In some implementations, the process 400 may be repeated until distortions are no longer visible. For example, the equations used in determining a target response in the second color model at each pixel in the display panel may instead be:

f′X(u,v)=fX(u,v)+Δx(u,v)×ax, 0<ax<1

f′Y(u,v)=fY(u,v)+Δy(u,v)×aY, 0<aY<1

f′Z(u,v)=fZ(u,v)+Δz(u,v)×az, 0<az<1

In some implementations, determining the distortion compensation profile may be done on a per panel basis. For example, the distortion compensation profile may be determined for each panel based on only images captured of that panel. In some implementations, determining the compensation profile may be done on a per panel basis. For example, a single compensation profile may be determined based on images of five percent of the panels in a lot and then the single compensation profile may be provided for all the panels in the lot. In some implementations, determining the distortion compensation profile may be done on a golden sample basis. For example, a distortion compensation profile may be determined based on images of a single panel and that compensation profile may be provided for all panels.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple compact disks (CDs), disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA or an ASIC.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (erasable programmable read-only memory), EEPROM (electrically erasable programmable read-only memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for driving an organic light emitting diode (OLED) display having a first portion with a first pixel density and a second portion with a second pixel density lower than the first pixel density, the method comprising:
receiving original image content represented in a first color model;
determining converted image content represented in a second color model from the original image content represented in the first color model;
obtaining a distortion compensation profile that compensates for differences in response characteristics between the first portion of the display and the second portion of the display;
determining compensated image content represented in the second color model based on the converted image content and the distortion compensation profile;
determining reconverted compensated image content represented in the first color model from the compensated image content represented in the second color model; and
providing the reconverted compensated image content represented in the first color model for display on a display panel.

2. The method of claim 1, wherein determining compensated image content represented in the second color model based on the converted image content and the distortion compensation profile comprises:
determining the compensated image content represented in the second color model based on an aggregation of the converted image content and the distortion compensation profile.

3. The method of claim 1, wherein the distortion compensation profile comprises a map of values in the second color model for each pixel in the original image content.

4. The method of claim 1, wherein the distortion compensation profile is determined based on images of the display panel captured by a camera that represents the images in the second color model.

5. The method of claim 1, wherein the first color model comprises a red, green, blue (RGB) color model.

6. The method of claim 1, wherein the second color model comprises a XYZ color model.

7. The method of claim 1, wherein obtaining a distortion compensation profile comprises:
retrieving the distortion compensation profile from a non-transitory computer-readable medium.

8. The method of claim 1, wherein obtaining a distortion compensation profile comprises:
receiving the distortion compensation profile before receiving the original image content represented in the first color model.

9. A system comprising:
one or more computers and one or more storage devices storing instructions that are operable, when executed by the one or more computers, to cause the one or more computers to perform operations comprising:
receiving original image content represented in a first color model;
determining converted image content represented in a second color model from the original image content represented in the first color model;
obtaining a distortion compensation profile that compensates for differences in response characteristics between the first portion of the display and the second portion of the display;
determining compensated image content represented in the second color model based on the converted image content and the distortion compensation profile;
determining reconverted compensated image content represented in the first color model from the compensated image content represented in the second color model; and
providing the reconverted compensated image content represented in the first color model for display on a display panel.

10. The system of claim 9, wherein determining compensated image content represented in the second color model based on the converted image content and the distortion compensation profile comprises:
determining the compensated image content represented in the second color model based on an aggregation of the converted image content and the distortion compensation profile.

11. The system of claim 9, wherein the distortion compensation profile comprises a map of values in the second color model for each pixel in the original image content.

12. The system of claim 9, wherein the distortion compensation profile is determined based on images of the display panel captured by a camera that represents the images in the second color model.

13. The system of claim 9, wherein the first color model comprises a red, green, blue (RGB) color model.

14. The system of claim 9, wherein the second color model comprises a XYZ color model.

15. The system of claim 9, wherein obtaining a distortion compensation profile comprises:
retrieving the distortion compensation profile from a non-transitory computer-readable medium.

16. A non-transitory computer-readable medium storing software comprising instructions executable by one or more computers which, upon such execution, cause the one or more computers to perform operations comprising:
receiving original image content represented in a first color model;
determining converted image content represented in a second color model from the original image content represented in the first color model;
obtaining a distortion compensation profile that compensates for differences in response characteristics between the first portion of the display and the second portion of the display;
determining compensated image content represented in the second color model based on the converted image content and the distortion compensation profile;
determining reconverted compensated image content represented in the first color model from the compensated image content represented in the second color model; and
providing the reconverted compensated image content represented in the first color model for display on a display panel.

17. The medium of claim 16, wherein determining compensated image content represented in the second color model based on the converted image content and the distortion compensation profile comprises:
determining the compensated image content represented in the second color model based on an aggregation of the converted image content and the distortion compensation profile.

18. The medium of claim 16, wherein the distortion compensation profile comprises a map of values in the second color model for each pixel in the original image content.

19. The medium of claim 16, wherein the distortion compensation profile is determined based on images of the display panel captured by a camera that represents the images in the second color model.

20. The medium of claim 16, wherein the first color model comprises a red, green, blue (RGB) color model.
